(19) United States
(12) Patent Application Publication
(10) Pub. No.: US 2006/0187066 A1
(43) Pub. Date: Aug. 24, 2006

(54) Armlet-type alarm

(76) Inventor: Mike Chen, Irvine, CA (US)

Correspondence Address: MIKE CHEN, 9F., No. 37, Dongsing Road, Xinyi District, Taipei City, 110, TW

(21) Appl. No.: 11/061,032

(22) Filed: Feb. 22, 2005

(51) Int. Cl. G08B 13/00; G08B 7/00; G08B 23/00

(52) U.S. Cl. 340/574; 340/815.69; 340/691.5; 340/693.9

(57) ABSTRACT

An armlet-type alarm includes a main body having a control circuit and a buzzer mounted therein, and a length-wise adjustable fastening band connected to the main body. The main body is provided at a top with a large-sized alarm push button assembly having a light-emitting device located therein, and a light-up switch for actuating the light-emitting device to emit light intermittently. One side of the main body includes a sound box, which uses a user's arm as one sidewall thereof and has a plurality of sound apertures provided therein. The armlet-type alarm may emits an intermittent warning light if so desired, and may be caused to emit a loud sound in an emergency simply by clapping the alarm push button assembly to actuate the buzzer inside the main body of the alarm.

### FIELD OF THE INVENTION

The present invention relates to an armlet-type alarm, which may emit an intermittent warning light when used as a nighttime jogging flasher, and may be caused to emit a loud sound in an emergency simply by clapping an alarm push button with the user's hand to actuate an internal buzzer.

### BACKGROUND OF THE INVENTION

For the purpose of safety, many people attach a flasher to their bikes or waists when engaging in some nighttime activities, such as riding a bicycle, jogging, walking, etc. Flashes from the flasher act to draw the attention of other people and/or vehicles to avoid undesired accidents in a dim environment. However, most of the conventional flashers may not be easily fixed or hung to the users' waists or other body areas, nor do they compliment the body engineering particularly when the users is moving. According to the body, the most ideal position to place a light-emitting device is on a user's upper arm.

Moreover, in some emergency situations, the conventional flasher alone is not sufficient or effective enough to quickly draw other people's attention. Therefore, some people may also carry a small-sized alarm to actuate in an emergency and emit sounds to draw other people's attention and quickly receive necessary aid.

However, it would be inconvenient and uncomfortable when the user wears the flasher and carries the alarm at the same time, particularly when he or she is exercising or involving themselves in some other outdoor activities. Moreover, in this sort of situation, it may prove too late to locate and actuate the alarm in case of emergency.

It is therefore tried by the inventor to develop an armlet-type alarm that combines the alarm and the flasher. This alarm could be conveniently worn on a user's upper arm to meet the body engineering, and thereby provide flashes as a warning signal and enable timely actuation of the alarm to effectively solve the above-mentioned inconveniences.

### SUMMARY OF THE INVENTION

The primary objective of the present invention is to provide an armlet-type alarm, which may emit an intermittent warning light when used as a nighttime jogging flasher, and may be caused to emit a loud sound in an emergency simply by clapping an alarm push button with the user's hand to actuate an internal buzzer.

To achieve the above and other objectives, this armlet-type alarm invention includes a main body, having a control circuit and a buzzer mounted therein, and a length-wise adjustable fastening band connected to the main body. The top of the main body is fitted with a large-sized alarm push button assembly having a light-emitting device located therein, and a light-up switch for actuating the light-emitting device to emit an intermittent light. One side of the main body includes a sound box, which uses a user's arm as one sidewall thereof and offers a plurality of sound apertures provided therein. The armlet-type alarm emits intermittent warning light flashes and may be caused to emit loud sound in an emergency simply by clapping the alarm push button assembly to actuate the buzzer inside the main body of the alarm.

This armlet-type alarm invention provides complete protection to the user in any activity at any time.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein

FIG. 1 is an exploded perspective view of an armlet-type alarm according to a preferred embodiment of the present invention;

FIG. 2 is an assembled perspective view of the armlet-type alarm of FIG. 1; and

FIG. 3 shows the wearing of the armlet-type alarm of the present invention on a user's upper arm.

### DETAILED DESCRIPTION OF THE PREFERRED EMBODIMENTS

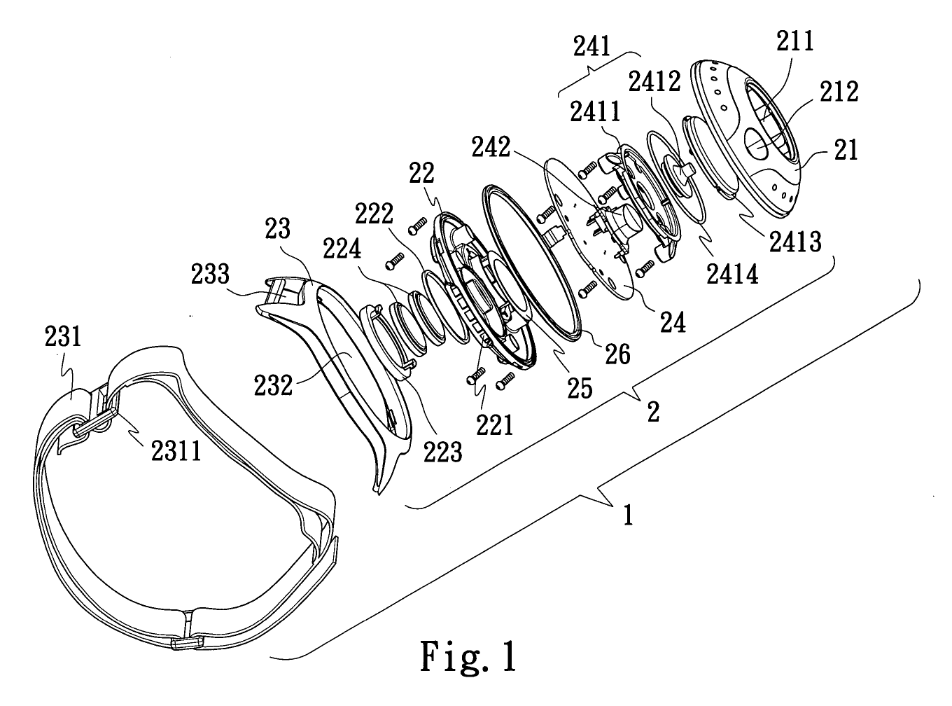

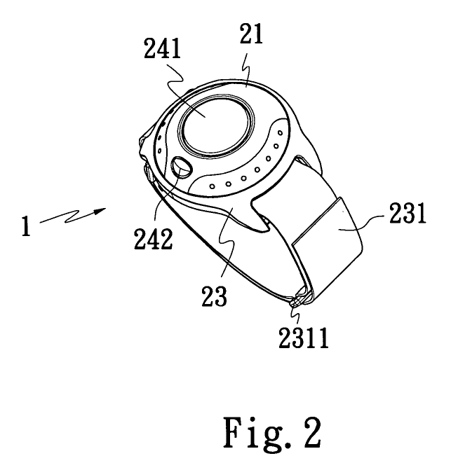

Please refer to exploded FIGS. 1 and 2 of assembled perspective views, respectively, of an armlet-type alarm according to a preferred embodiment of the present invention.

As shown, the armlet-type alarm, which is generally denoted by reference numeral 1, includes a main body 2 and a fastening band 231. The main body 2 includes a convex upper cover 21 defining a first and a second opening 211, 212, a lower cover 22 adapted to close to the bottom of the upper cover 21 and including a recessed section provided at one side to function like a sound box 221. This also includes a case frame 23 defining a central opening 232 for receiving the lower cover 22 therein and two diametrically opposite band holes 233 for the fastening band 231 to extend therethrough. The fastening band 231 is made of an elastic and flexible material and has two adjustable buckles 2311 provided thereon.

A circuit board 24 having a control circuit provided thereon and buzzer 25 are disposed between the upper and the lower cover 21, 22. The buzzer 25 is located in the lower cover 22. Two button batteries 224 are tightly pressed against a rear side of the lower cover 22 using a battery cap 223. A waterproof gasket 222 is fitted around the battery cap 223 to protect the batteries 224 against water.

The circuit board 24 is located above the buzzer 25 and connected to a large-sized alarm push button assembly 241 and a light-up switch 242. The alarm push button assembly 241 includes a bottom disk 2411, a push button 2412 mounted on a top of the bottom disk 2411, and a light-emitting device (not shown). It also includes a transparent hood 2413 adapted to tightly fit onto the bottom disk 2411. Finally, a waterproof gasket 2414 fitted around a joint of the bottom disk 2411 and the transparent hood 2413, are also present. The light-up switch 242 is used to turn on the light-emitting device in the alarm push button assembly 241, so that the light-emitting device emits light intermittently. The control circuit on the circuit board 24 may include a voice mono-chip on which multi-staged warning sounds may be pre-recorded. The control circuit also controls the light-emitting device in the alarm push button assembly 241 to intermittently emit light in multiple stages.

The first and the second openings 211 and 212 on the upper cover 21 are a larger and a smaller opening respectively formed on the top center outer edge of the upper cover 21 for the alarm push button assembly 241 and the light-up switch 242 to correspondingly locate therein and expose therefrom, as shown in FIG. 2. A waterproof gasket 26 is fitted around a joint of the upper and the lower cover 21 and 22.

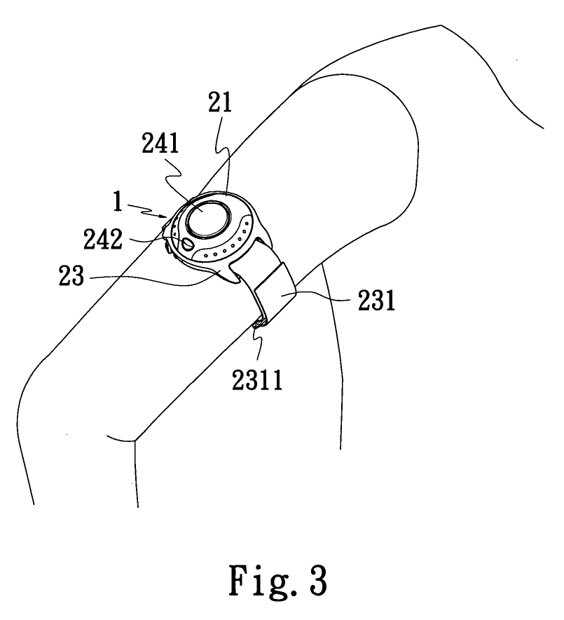

Please refer to FIG. 3 depicting how the armlet-type alarm 1 of the present invention is to be worn on a user's upper arm. To do so, first tie the elastic and flexible fastening band 231 around the user's upper arm at a suitable position with the side of the main body 2 having the sound box 221 facing downward. This is placed as such lest sweat, rainwater or other kinds of liquid should directly invade the inner space of the main body 2. Of course, the user may otherwise wear the armlet-type alarm with the sound box 221 facing upward when the invasion of water or moisture is not a problem. In the present invention, the user's arm is utilized as a wall at one side of the sound box 221, so that sound emitted from the buzzer 25 first oscillates between the user's arm and the sound box 221. This amplified sound becomes much louder when it is finally sent out of the sound box 221. More specifically, the sound emitted from the buzzer 25 is sent to the sound box 221 via a plurality of sound aperture (not shown). The sound box 221 with a limited and narrow internal space is best designed to serve as an optimal sound resonant cavity to produce an amplified and most effective warning sound. The amplified warning sound is concentrated at a center of the sound box 221 and then transmitted upward or downward. The sound box 221 with the user's arm as one sidewall thereof enables an extended sound field to produce the most effective sound that can be transmitted for maximum distance in space.

After the armlet-type alarm 1 has been properly worn on the user's upper arm, the light-up switch 242 may be pushed downward. After doing this, the light-emitting device inside the alarm push button assembly 241 starts emitting light intermittently to catch other people's attention. The intermittent light produces a visually warning effect particularly in the night. In case of emergency, the user may conveniently use the other hand to quickly hit and thereby actuate the flashing alarm push button assembly 241, so that the control circuit in the main body 2 causes the buzzer 25 to loudly sound. The sound emitted from the buzzer 25 oscillates between the user's and the sound box 221 and becomes even louder and is transmitted farther to fully extend the function of the present invention as a safety flasher and emergency alarm. With the above arrangements, it is possible for the armlet-type alarm of the present invention to emit warning flashes when the user is engaging in general activities, and to emit loud sound in an emergency simply by clapping the alarm push button at the top center of the alarm to easily and quickly actuate the buzzer inside the main body of the alarm. Therefore, the present invention provides complete protection to the user in any activity at any time.

What is claimed is:

1. An armlet-type alarm, comprising of a main body, having a control circuit and a buzzer mounted therein, and a length-wise adjustable fastening band connected to said main body; said main body being provided at a top with a large-sized alarm push button assembly having a light-emitting device located therein, and a light-up switch for actuating said light-emitting device to emit light intermittently, one side of said main body is comprised of a sound box, which uses a user's arm as one sidewall thereof and has a plurality of sound apertures provided therein.

2. The armlet-type alarm as claimed in claim 1, wherein said control circuit includes a voice mono-chip having multi-staged warning sounds pre-recorded thereon.

3. The armlet-type alarm as claimed in claim 1, wherein said control circuit is adapted to control said light-emitting device inside said alarm push button assembly to emit intermittent light in multiple stages.

4. The armlet-type alarm as claimed in claim 1, wherein said fastening band is made of an elastic and flexible material and has two adjustable buckles provided thereon.
